(19) United States
(12) Patent Application Publication
(10) Pub. No.: US 2012/0069038 A1
(43) Pub. Date: Mar. 22, 2012

(54) Image Processing Method and Image Display System Utilizing the Same

(75) Inventors: Wei-Ting Suen, Sinshih Township (TW); Ling-Hsiu Huang, Sinshih Township (TW)

(73) Assignee: HIMAX MEDIA SOLUTIONS, INC., Sinshih Township (TW)

(21) Appl. No.: 12/885,982

(22) Filed: Sep. 20, 2010

(51) Int. Cl. G09G 5/02

(52) U.S. Cl. 345/589

(57) ABSTRACT

An image display system including an adjuster, a first analysis module, a second analysis module and a brightness compensation module is disclosed. The adjuster utilizes a specific method and a depth information to adjust a processed image to generate a first image and a second image. The first analysis module analyzes the first image to obtain a first image distribution result. The second analysis module analyzes the second image to obtain a second image distribution result. The brightness compensation module adjusts brightness of the first and the second images according to the first and the second image distribution results. The adjusted first image serves as a left-eye image component and the adjusted second image serves as a right-eye image component.

### BACKGROUND OF THE INVENTION

1. Field of the Invention

The invention relates to an image display system, and more particularly to an image display system for transforming a 2D image into a 3D image.

2. Description of the Related Art

With technological development, display technology has continuously developed in recent years. Monochrome televisions and color televisions were developed earlier on. Now, flat televisions are a newly developed technology. The flat televisions have the favorable advantages of a thin profile and high quality. To display actual images, display technology has been developed from 2D (two-dimensional) to 3D (three-dimensional). The 3D image displays a solid effect.

### BRIEF SUMMARY OF THE INVENTION

In accordance with an embodiment, an image display system comprises an adjuster, a first analysis module, a second analysis module and a brightness compensation module. The adjuster utilizes a specific method and a depth information to adjust a processed image to generate a first image and a second image. The first analysis module analyzes the first image to obtain a first image distribution result. The second analysis module analyzes the second image to obtain a second image distribution result. The brightness compensation module adjusts brightness of the first and the second images according to the first and the second image distribution results. The adjusted first image serves as a left-eye image component and the adjusted second image serves as a right-eye image component.

In accordance with an embodiment, an image display system comprises an image generating device. The image generating device generates a 3D image comprising a left-eye image component and a right-eye image component, comprises a depth generating unit, an image processing unit, an analysis module, a brightness compensation module and an adjuster. The depth generating unit generates depth information according to a 2D image. The image processing unit processes the 2D image to generate a processed image according to the depth information. The analysis module analyzes the processed image to obtain an image distribution result. The brightness compensation module adjusts brightness of the processed image to generate an adjusted image according to the image distribution result. The adjuster utilizes a specific method and the depth information to adjust the adjusted image for generating the left-eye and the right-eye image components.

An exemplary embodiment of an image processing method for generating a 3D image comprising a left-eye image component and a right-eye image component is described in the following. A specific method and a depth information are utilized to adjust a processed image to generate a first image and a second image. The first image is analyzed to obtain a first image distribution result. The second image is analyzed to obtain a second image distribution result. Brightness of the first and the second images are adjusted according to the first and the second image distribution results. The adjusted first image serves the left-eye image component and the adjusted second image serves the right-eye image component.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of an image display system;

FIG. 2 is a schematic diagram of an exemplary embodiment of the image processing device;

FIG. 3A is a schematic diagram of an exemplary embodiment of the adjustment unit 250;

FIG. 3B is an image histogram indicating the occurrence number of each gray level in a frame;

FIG. 4 is a schematic diagram of another exemplary embodiment of the adjustment unit;

FIG. 5 is a schematic diagram of an exemplary embodiment of an image processing method;

FIG. 6 is a schematic diagram of an exemplary embodiment of processing the processed image; and

FIG. 7 is a schematic diagram of another exemplary embodiment of processing the processed image.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

A 2D image is analyzed to obtain depth information. The depth information is utilized to generate a left-eye image component and a right-eye image component. The left-eye and the right-eye image components are successively displayed to show 3D solid effect.

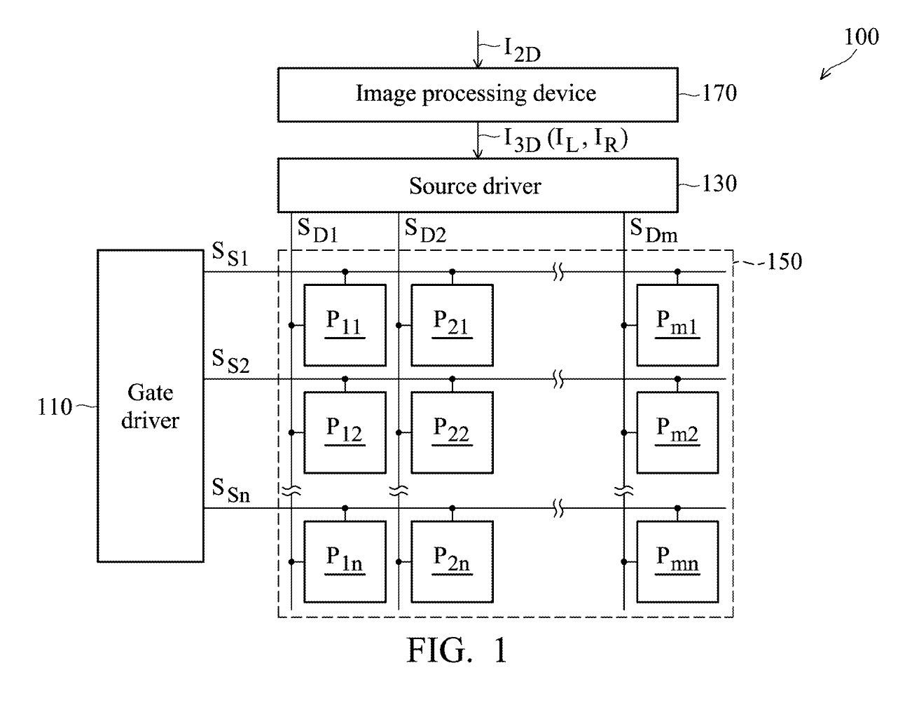

FIG. 1 is a schematic diagram of an exemplary embodiment of an image display system. The image display system 100 comprises a gate driver 110, a source driver 130, a display region 150 and an image processing device 170. The gate driver 110 provides scan signals S_{S1}˜S_{Sn}. The source driver 130 provides data signals S_{D1}˜S_{Dm} according to a 3D image I_{3D}. The 3D image I_{3D} comprises a left-eye image component I_{L} and a right-eye image component I_{R}.

The display region 150 comprises pixel units P₁₁˜Pₘₙ. The pixel units P₁₁˜Pₘₙ receive data signals S_{D1}˜S_{Dm} according to the scan signals S_{S1}˜S_{Sn} and display a corresponding image according to the data signals S_{D1}˜S_{Dm}. Since the principles of the gate driver 110, the source driver 130 and the pixel units P₁₁˜Pₘₙ are well known to those skilled in the field, descriptions of the gate driver 110, the source driver 130 and the pixel units P₁₁˜Pₘₙ are omitted for brevity.

The image processing device 170 receives a 2D input image I_{2D} to generate the 3D image I_{3D} comprising the left-eye image component I_{L} and the right-eye image component L_{R}. In this embodiment, a 3D solid effect can be accomplished when the source driver 130 generates the data signals S_{D1}˜S_{Dm} according to the left-eye image component I_{L} and the right-eye image component L_{R} successively.

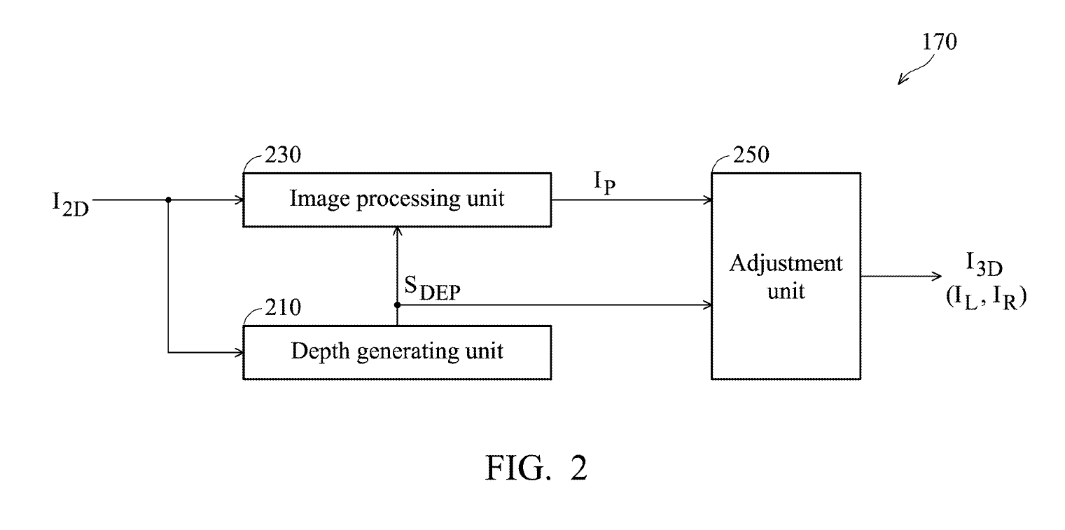

FIG. 2 is a schematic diagram of an exemplary embodiment of the image processing device. The image processing device 170 comprises a depth generating unit 210, an image processing unit 230 and an adjustment unit 250. The depth generating unit 210 generates depth information S_{DEP} according to the 2D image I_{2D}. In this embodiment, the depth generating unit 210 analyzes the 2D image I_{2D} to generate the depth information S_{DEP}. The depth information S_{DEP} can be referred to as a depth map.

The image processing unit 230 processes the 2D image I_{2D} to generate a processed image I_{P} according to the depth information S_{DEP}. The 2D image I_{2D} comprises various image components. In one embodiment, the image components of the 2D image I_{2D} are processed by a sharpness procedure. For example, if a portion of the image components is close to a foreground image component, the sharpness of the portion of the image components is adjusted. The adjusted level of the portion of the image components is higher than another portion of the image components, wherein another portion of the image components is distant from the foreground. Thus, the adjusted result (i.e. the processed image I_{P} generated by the image processing unit 230) has a 3D solid effect.

In some embodiments, the image processing unit 230 executes one or a combination of a sharpness procedure, a contrast procedure, a color procedure and a brightness procedure according to the depth information S_{DEP}.

The adjustment unit 250 adjusts the processed image I_{P} to generate the 3D image I_{3D} according to the depth information S_{DEP}. In this embodiment, the 3D image I_{3D} comprises a left-eye image component I_{L} and a right-eye image component I_{R}. When the image display system successively displays the left-eye image component I_{L} and the right-eye image component I_{R}, a 3D solid effect can be accomplished.

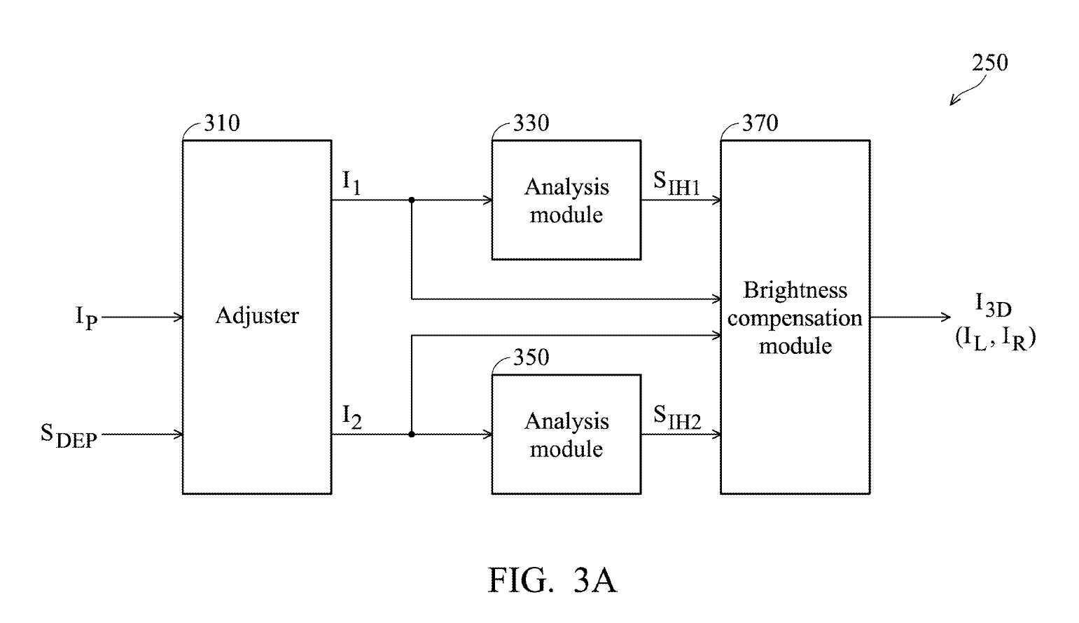

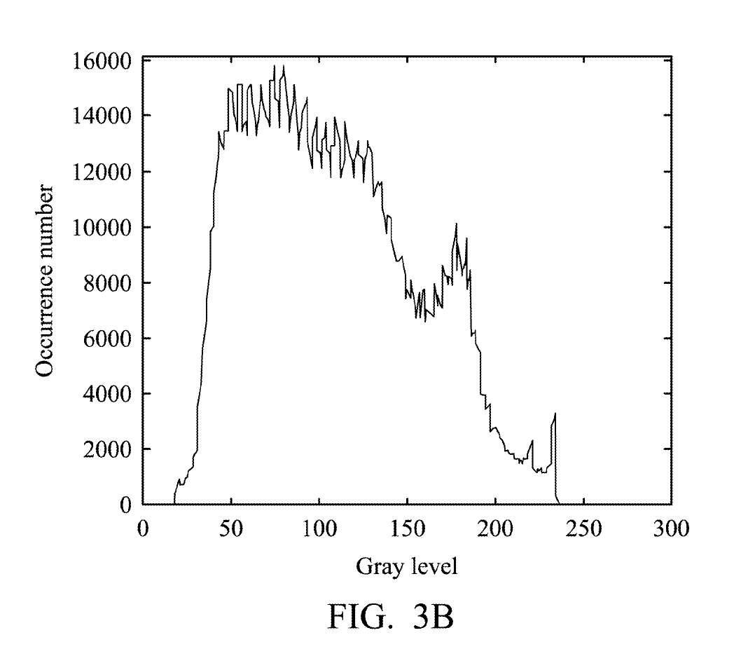

FIG. 3A is a schematic diagram of an exemplary embodiment of the adjustment unit. The adjustment unit 250 comprises an adjuster 310, analysis modules 330, 350 and a brightness compensation module 370.

The adjuster 310 utilizes a specific method and the depth information S_{DEP} to adjust the processed image I_{P} and generates images I₁ and I₂ according to the adjusted result. In this embodiment, the specific method is a depth image based rendering (DIBR) method. The DIBR method generates new images (e.g. I₁ and I₂) according to an input image (e.g. I_{P}) and a corresponding depth (e.g. S_{DEP}) relating to the input image.

The analysis module 330 analyzes the image I₁ to obtain an image distribution result S_{IH1}. The analysis module 350 analyzes the image I₂ to obtain an image distribution result S_{IH2}. In this embodiment, the analysis modules 330 and 350 execute a histogram analysis for the images I₁ and I₂ to obtain brightness distributions of the images I₁ and I₂.

In one embodiment, the image distribution results S_{IH1} and S_{IH2} generated by the analysis modules 330 and 350 are image histograms of the images I₁ and I₂ respectively. The brightness distributions of the images I₁ and I₂ are obtained according to the image histogram. FIG. 3B is an image histogram indicating the occurrence number of each gray level in a frame. The image histogram can represent the characteristic of the frame, such as light and dark degrees.

The brightness compensation module 370 adjusts the brightness of the images I₁ and I₂ according to the image distribution results S_{IH1} and S_{IH2}. The adjusted results serve as the left-eye image component I_{L} and the right-eye image component I_{R} respectively. In this embodiment, the left-eye image component I_{L} and the right-eye image component I_{R} are successively transmitted to the source driver 130. Further, the brightness compensation module 370 depends upon the image distribution results S_{IH1} and S_{IH2} to dynamically adjust the brightness of the images I₁ and I₂ such that an over-saturation issue does not occur in the adjusted images I₁ and I₂.

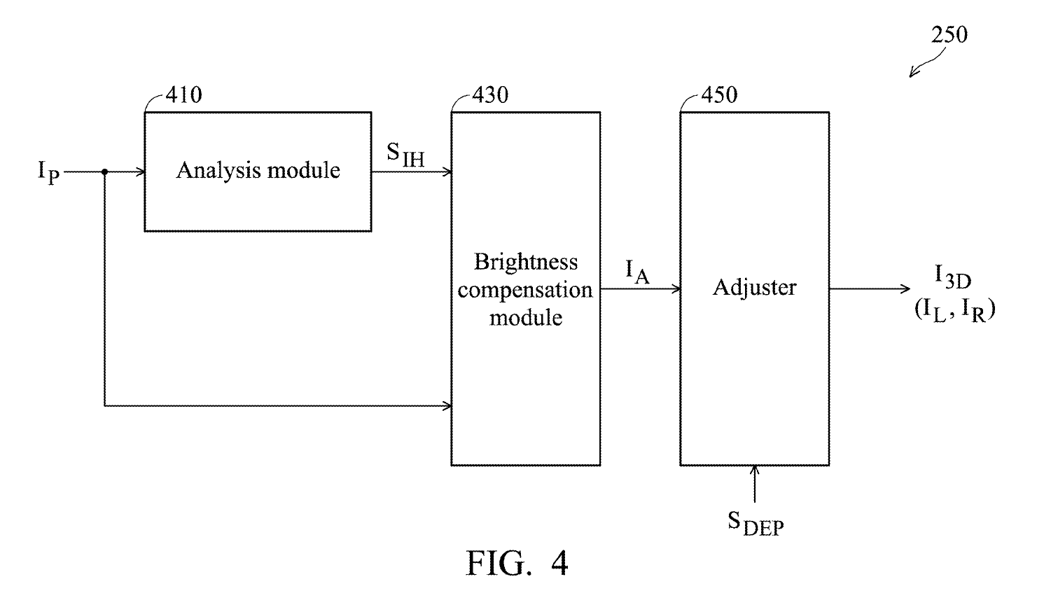

FIG. 4 is a schematic diagram of another exemplary embodiment of the adjustment unit. The adjustment unit 250 comprises an analysis module 410, a brightness compensation module 430 and an adjuster 450. The analysis module 410 analyzes the processing image I_{P} to obtain an image distribution result S_{IH}. In this embodiment, the analysis module 410 compiles the brightness of the processing image I_{P}. In another embodiment, the analysis module 410 does not employ the depth information S_{DEP} to obtain the image distribution result S_{IH}. Thus, the image distribution result S_{IH} does not relate to the depth information S_{DEP}.

The brightness compensation module 430 adjusts the brightness of the processing image I_{P} to generate an adjusted image I_{A} according to the image distribution result S_{IH}. In one embodiment, the brightness compensation module 430 does not employ the depth information S_{DEP} to generate the adjusted image I_{A}. Thus, the adjusted image I_{A} does not relate to the depth information S_{DEP}. The adjuster 470 utilizes a specific method and the depth information S_{DEP} to adjust the adjusted image I_{A} such that a left-eye image component I_{L} and a right-eye image component I_{R} are generated. In this embodiment, the specific method is a DIBR method.

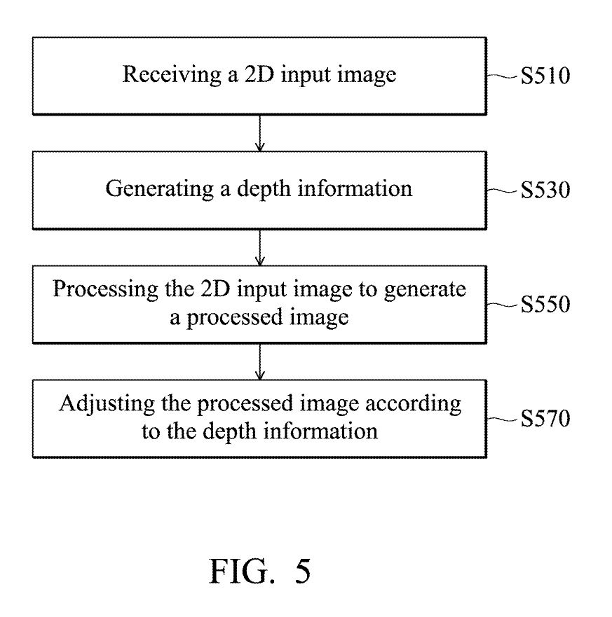

FIG. 5 is a schematic diagram of an exemplary embodiment of an image processing method. The image processing method is capable of generating a 3D image. In this embodiment, the 3D image comprises a left-eye image component and a right-eye image component. The left-eye image component and the right-eye image component are successively displayed to accomplish a 3D solid effect.

In step S510, a 2D image is received. Depth information is generated according to the 2D image (step S530). The invention does not limit the method of generating the depth information.

The depth information is utilized to process the 2D image for generating a processed image (step S550). The invention does not limit the method of processing the 2D image. In some embodiments, the 2D image is processed by one or a combination of a sharpness procedure, a contrast procedure, a color procedure and a brightness procedure.

The processed image is adjusted to generate a left-eye image component and a right-eye image component according to the depth information (step S570). In this embodiment, the left-eye image component and the right-eye image component are successively displayed to perform a 3D solid effect.

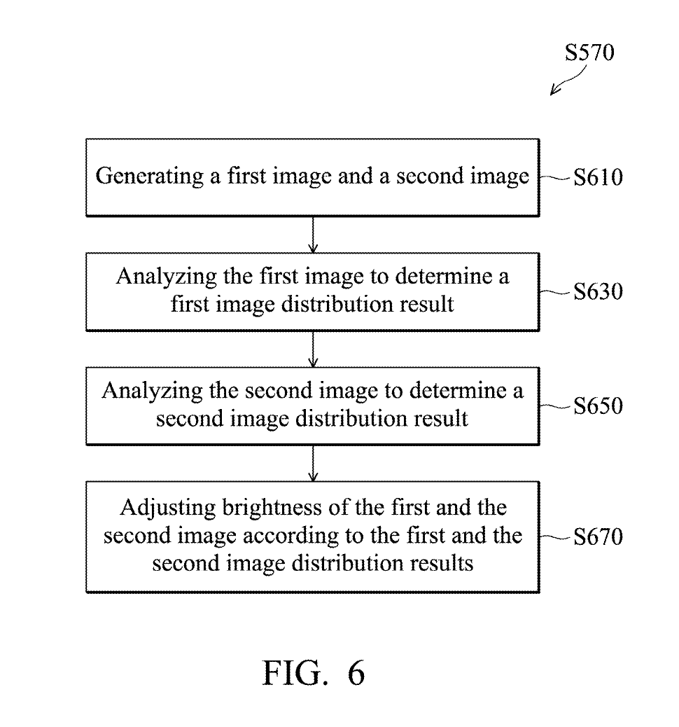

FIG. 6 is a schematic diagram of an exemplary embodiment of processing the processed image. A specific method and the depth information are utilized to adjust the processed image to generate a first image and a second image (step S610). The invention does not limit the type of the specific method. In one embodiment, the specific method is a DIBR method.

The first image is analyzed to obtain a first image distribution result (step S630). The second image is analyzed to obtain a second image distribution result (step S650). The invention does not limit the method of analyzing the first or the second method. In one embodiment, the first and the second images are analyzed to obtain brightness distribution of the first and the second images. The analyzed result is utilized to generate an image histogram. The image histogram serves as the image distribution result.

The analyzed results (e.g. the first and the second image distribution results) obtained by the steps S630 and S650 are utilized to adjust the brightness of the first and the second images (step S670). In this embodiment, the adjusted result generated by the step S670 serves a left-eye image component and a right-eye image component.

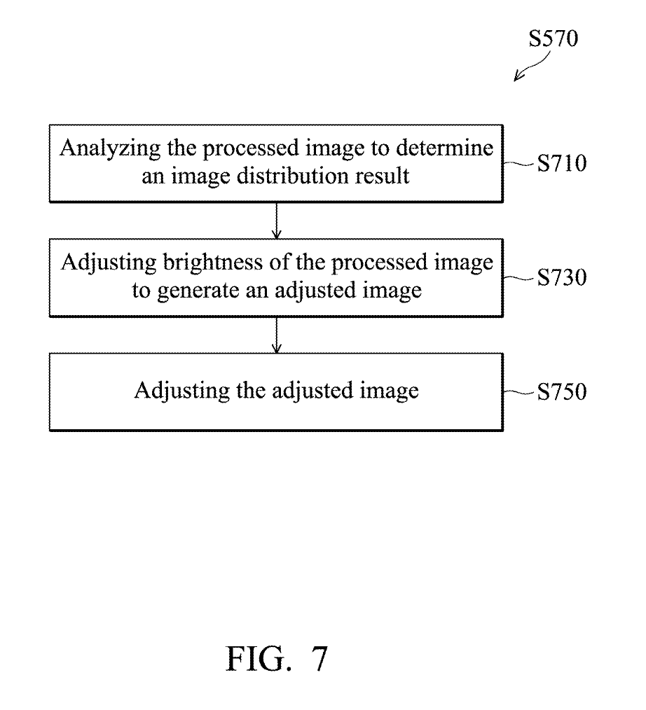

FIG. 7 is a schematic diagram of another exemplary embodiment of processing the processed image. In this embodiment, the processed image generated by the step S550 is analyzed to obtain an image distribution result (step S710). The invention does not limit the method of analyzing the processed image. In one embodiment, brightness of the processed image is analyzed.

The brightness of the processed image is adjusted to generate an adjusted image according to the image distribution result (step S730). Then, a specific method with the depth information is utilized to adjust the adjusted image such that a left-eye image component and a right-eye image component are generated (step S750). In one embodiment, the specific method utilized in the step 750 is a DIBR method.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image display system comprising:
an adjuster utilizing a specific method and a depth information to adjust a processed image to generate a first image and a second image;
a first analysis module analyzing the first image to obtain a first image distribution result;
a second analysis module analyzing the second image to obtain a second image distribution result; and
a brightness compensation module adjusting brightness of the first and the second images according to the first and the second image distribution results, wherein the adjusted first image serves as a left-eye image component and the adjusted second image serves as a right-eye image component.

2. The image display system as claimed in claim 1, wherein the specific method is a depth image based rendering (DIBR) method.

3. The image display system as claimed in claim 1, further comprising:
a depth generating unit generating the depth information according to a 2D image.

4. The image display system as claimed in claim 3, further comprising:
an image processing unit processing the 2D image to generate the processed image according to the depth information.

5. The image display system as claimed in claim 4, wherein the image processing unit utilizes the depth information to execute a procedure for the 2D image, and wherein the procedure is a sharpness procedure, a contrast procedure, a color procedure or a brightness procedure.

6. The image display system as claimed in claim 1, further comprising:
a gate driver providing a plurality of scan signals;
a source driver providing a plurality of data signals according to the left-eye image component and the right-eye image component; and
a display region comprising a plurality of pixel units, wherein the pixel units receive the scan signals and the data signals.

7. An image display system comprising:
an image processing device receiving a 2D image to generate a 3D image comprising a left-eye image component and a right-eye image component, wherein the image processing device comprises:
a depth generating unit generating a depth information according to the 2D image;
an image processing unit processing the 2D image to generate a processed image according to the depth information;
an analysis module analyzing the processed image to obtain an image distribution result;
a brightness compensation module adjusting brightness of the processed image to generate an adjusted image according to the image distribution result; and
an adjuster utilizing a specific method and the depth information to adjust the adjusted image for generating the left-eye and the right-eye image components.

8. The image display system as claimed in claim 7, wherein the specific method is a DIBR method.

9. The image display system as claimed in claim 7, further comprising:
a gate driver providing a plurality of scan signals;
a source driver providing a plurality of data signals according to the 3D image; and
a display region comprising a plurality of pixel units, wherein the pixel units receive the scan signals and the data signals.

10. An image processing method for generating a 3D image comprising a left-eye image component and a right-eye image component, comprising:
utilizing a specific method and a depth information to adjust a processed image to generate a first image and a second image;
analyzing the first image to obtain a first image distribution result;
analyzing the second image to obtain a second image distribution result; and
adjusting brightness of the first and the second images according to the first and the second image distribution results, wherein the adjusted first image serves the left-eye image component and the adjusted second image serves the right-eye image component.

11. The image processing method as claimed in claim 10, further comprising:
receiving a 2D image; and
generating the depth information according to the 2D image.

12. The image processing method as claimed in claim 11, further comprising:
utilizing the depth information to process the 2D image to generate the processed image.

13. The image processing method as claimed in claim 12, wherein the step of processing the 2D image is to execute a sharpness procedure, a contrast procedure, a color procedure or a brightness procedure.

14. The image processing method as claimed in claim 10, wherein the specific method is a DIBR method.
